(19) United States
(12) Patent Application Publication
(10) Pub. No.: US 2003/0004394 A1
(43) Pub. Date: Jan. 2, 2003

(54) Incubator system provided with a temperature control system

(76) Inventor: Wilhelmus Marinus Carpay, Liempde (NL)

Correspondence Address: Elie H. Gendloff, Ph.D., Esq., AMSTER, ROTHSTEIN & EBENSTEIN, 90 Park Avenue, New York, NY, 10016, US

(21) Appl. No.: 10/096,545

(22) Filed: Mar. 12, 2002

Related U.S. Application Data
(60) Provisional application No. 60/297,617, filed on Jun. 11, 2001.

(30) Foreign Application Priority Data
Mar. 13, 2001 (EP) 01200948.6

(51) Int. Cl. A61G 11/00

(52) U.S. Cl. 600/22

(57) ABSTRACT

The invention pertains to an incubator system provided with a temperature control system comprising a chamber that is suitable for housing a substrate, and at least one wall that is partially or wholly transparent, characterized in that the incubator system comprises a heater, a system for providing a thermal flow, and a thermal resistance barrier that provides at least some insulation between the chamber and the partially or wholly transparent wall.

### CROSS REFERENCE TO RELATED APPLICATION

This application claims priority to U.S. Provisional Patent Application Serial No. 60/296,617, filed Jun. 11, 2001, and European Patent Application No. 01200948.6, filed Mar. 13, 2001.

### BACKGROUND OF THE INVENTION

(1) Field of the Invention

The invention pertains to an incubator system provided with a temperature control system.

(2) Description of the Related Art

Incubation systems are known in the art. For instance, in PCT/US00/24885 an incubator system was disclosed suitable for comprising a substrate such as a metal oxide membrane having through-going oriented channels that can be manufactured cheaply through electrochemical etching of a metal sheet. Such membranes have oriented channels with well controlled diameter and advantageous chemical surface properties. When used in an assay the channels in at least one area of the surface of the electrochemically manufactured metal oxide membrane are provided with a first binding substance capable of binding to an analyte.

According to a preferred embodiment the metal oxide membrane is comprised of aluminum oxide. Reagents used in these assays are immobilized in the channels of the substrate and the sample fluid will be forced through the channels to be contacted with the reagents.

The device comprises one or more round wells with a certain diameter, said wells exposing a substrate of a specific thickness, said substrate having oriented through-going channels, and the area of the substrate exposed in the well being provided with at least one binding substance specific for at least one of said analytes. An amount of sample fluid is added to one or more of the wells of the device, the amount of added sample fluid being calculated on the basis of the dimensions of the wells and the substrate. An alternating flow is generated through the substrate in the wells whereby the liquid volume of sample fluid is forced to pass through the channels in the substrate from the upper side of the substrate to the lower side of the substrate and back at least one time, under conditions that are favorable to a reaction between an analyte present in the sample and the binding substances. Any signal generated in any of the wells is read and from said signals the presence, amount, and/or identity of said one or more analytes are determined. When the upper wall of said incubator is covered by a transparent material, such as a glass cover, the wells can be analyzed and the reading signal can be determined through the glass. It goes without saying that it is advantageous to close the incubator at the side of the wells to prevent contamination and an uncontrolled process. When closed, the well must remain visible to enable measurement of the generated signals. A problem is then that water that is present in the incubator system condenses onto the walls that are relatively cold. The condensation of the water onto a glass cover seriously decreases the transparency thereof, thereby hampering the determination of the signals.

### BRIEF SUMMARY OF THE INVENTION

It is an object of the present invention to provide a solution and to prevent condensation of water onto the transparent wall.

The present invention therefore provides an incubator system provided with a temperature control system comprising a chamber that is suitable for housing a substrate, and at least one wall that is partially or wholly transparent, characterized in that the incubator system comprises a heater, a system for providing a thermal flow, and a thermal resistance barrier that provides at least some thermal insulation between the chamber and the partially or wholly transparent wall.

The invention is further explained by reference to the drawings. Of course, it is clear that the invention is not restricted to these embodiments which can be varied in a number of ways within the scope of the claims.

### BRIEF DESCRIPTION OF THE SEVERAL VIEWS OF THE DRAWINGS

FIG. 1 shows a cross-section of an embodiment of the invention.

FIG. 2 shows in more detail the incubator system of the embodiment of FIG. 1.

### DETAILED DESCRIPTION OF THE INVENTION

Referring to the figures there is shown an embodiment of the incubator system of the invention. Generally, the incubator system comprises a casing 1 made of a metal or another heat-conducting material and a wall 2 that is partially or wholly transparent. These transparent parts are made of glass or transparent plastics, such as Plexiglass®, and the like. The transparent parts are at least situated above the wells, so that the sample signal can be determined. The system comprises a chamber 14, which in this embodiment contains as a substrate an array-membrane holder system with an array-membrane 3 and a holder 4 comprising wells 5, having for instance a cylindrical structure wherein the sample can be introduced. The array-membranes are known as such, for instance from EP 0 975 427. The array-membrane holder comprising the wells can be made of any material, for instance, metals or plastics. The incubator system may further comprise one or more switching means 10, in order to select the array cuvettes in which the sample flow is to be driven by a pressure control system (not further shown). At least one heater 6 is required to keep the temperature within well defined narrow ranges. The temperature is measured by one or more temperature sensors 11. The heater 6 can be any sort of heater, but usually it is electrically driven, such as by means of a spiral filament. Preferably, the heater 6 and the temperature sensor(s) 11 are connected to a controller (not shown), so that a temperature control system with feedback loop is obtained.

The incubator system further comprises a thermal resistance barrier 8 that is provided between the transparent wall 2 and the array-membrane holder 4. This thermal resistance barrier completely separates the array-membrane holder from the transparent wall. In the system shown a thermal flow is generated for keeping the temperature constant within the array-membrane holder system. In a preferred embodiment a circulating thermal flow is generated. This thermal flow results in a heat flow in the direction from the thermal resistance barrier 8 to the array-membrane holder 4. Such a thermal flow is provided by a thermal flow system 7, which may comprise a heat pump, a heat exchanger, or preferably, a Peltier element. As an alternative the thermal flow system can be made with two separate heating elements. The space between the thermal resistance barrier and the array-membrane holder is filled by a metal or another heat-conducting material 13, which may be different or the same as the metal or the heat-conducting material 1.

The thermal resistance barrier can have a single-layered structure or a multi-layered structure, each layer being made of any well chosen heat-resistant material that has suitable heat capacitance characteristics such that the instrument can be controlled in two ways, i.e., the temperature height at sample level, and the temperature gradient in and between the different sections of the incubator system. The thermal resistance barrier can be made of any heat-resistant material. Preferably, one or more organic polymeric materials are used, such as polyvinylchloride, polycarbonate, and the like. When multi-layered structures are used, a combination of such materials can be applied.

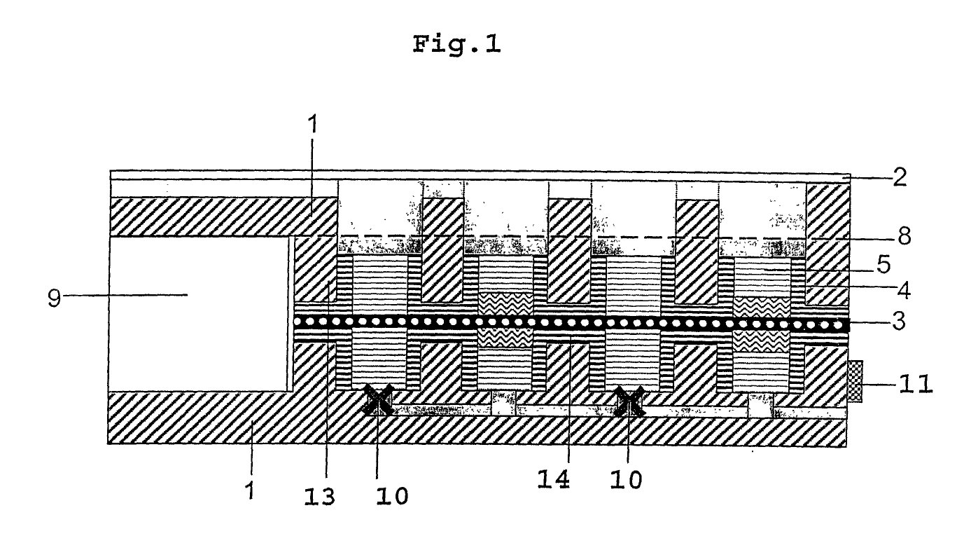

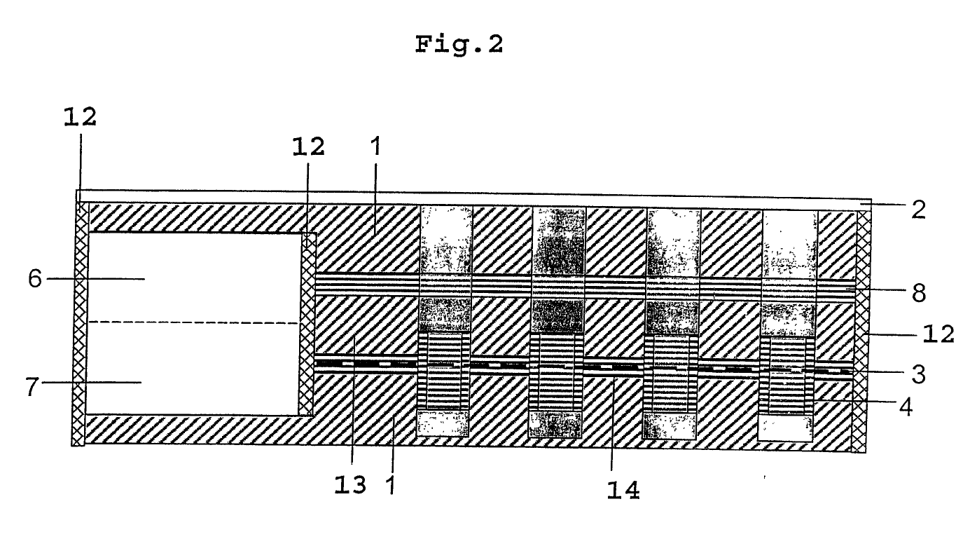

The heating system 9 in the embodiment of the FIGS. 1 and 2 consists of a heating element in series with, for instance, a Peltier element. The latter will generate a circulating heat flow through the incubator system such that the temperature of the transparent wall (i.e., the cover) will always be higher than the temperature of the sample volume, notwithstanding major cooling effects across the transparent cover towards ambient temperature. As mentioned alternative embodiments can be used to provide a heat flow.

The temperature sensor 11 is preferably located on the casing 1 near the array-membrane holder. Because of the relatively high heat conductance characteristics of the aluminum surrounding (if an aluminum casing is used) the array-membrane temperature accuracy of the array-membrane and the sample fluid will be high throughout the chamber. Preferably, the heater and the system for providing the thermal flow are positioned together in the heating system. More preferably, the heater and the system for providing the thermal flow are thermally isolated from the array-membrane holder and the thermal resistance barrier. In another preferred embodiment the heater and the system for providing the circular thermal flow, or together as the heating system, are thermally isolated from the array-membrane holder and the thermal resistance barrier by using thermal isolation material 12. It is advantageous to house the heating system partially or wholly in such isolation material to provide a sufficient heat stream from the thermal resistance barrier to the array-membrane holder. The usual thermal isolation material that is known to the skilled man can be used therefor. Such systems are preferred when a circulating thermal flow is to be obtained.

It is noted that a heat sink or other suitable heat discharging means can be provided at the lower side of the casing 1. In this manner the temperature of the array-membrane can be maintained at a desired level even without using a Peltier element in the heating system 7 if the temperature gradient in the system is sufficient to maintain a thermal flow. The heat sink can be coupled to the lower side of the casing 1 through a Peltier element, if desired. With such a heat discharging means in the incubator system described a temperature can be set below the ambient temperature.

Other embodiments within the scope of the claims herein will be apparent to one skilled in the art from consideration of the specification or practice of the invention as disclosed herein. It is intended that the specification be considered exemplary only, with the scope and spirit of the invention being indicated by the following claims.

In view of the above, it will be seen that the several advantages of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

What is claimed is:

1. An incubator system provided with a temperature control system comprising a chamber that is suitable for housing a substrate, and at least one wall that is partially or wholly transparent, characterized in that the incubator system comprises a heater, a system for providing a thermal flow, and a thermal resistance barrier that thermally separates the chamber and the partially or wholly transparent wall.

2. The incubator system of claim 1, wherein the system for providing a thermal flow comprises a second heater, a heat pump, a heat exchanger, or a Peltier element.

3. The incubator system of claim 1, wherein the array-membrane holder is made of polycarbonate.

4. The incubator system of claim 2, wherein the array-membrane holder is made of polycarbonate.

5. The incubator system of claim 1, wherein the thermal resistance barrier has a single-layer structure.

6. The incubator system of claim 2, wherein the thermal resistance barrier has a single-layer structure.

7. The incubator system claim 1, wherein the thermal resistance barrier has a multi-layer structure.

8. The incubator system claim 2, wherein the thermal resistance barrier has a multi-layer structure.

9. The incubator system of claim 1, wherein the thermal resistance barrier is made of polyvinylchloride, polycarbonate, or a combination thereof.

10. The incubator system of claim 2, wherein the thermal resistance barrier is made of polyvinylchloride, polycarbonate, or a combination thereof.

11. The incubator system of claim 1, wherein the heater and the system for providing the thermal flow are positioned together in a heating system.

12. The incubator system of claim 2, wherein the heater and the system for providing the thermal flow are positioned together in a heating system.

13. The incubator system of claim 1, wherein the heater and the system for providing the thermal flow are thermally isolated from the array-membrane holder and the thermal resistance barrier.

14. The incubator system of claim 2, wherein the heater and the system for providing the thermal flow are thermally isolated from the array-membrane holder and the thermal resistance barrier.

15. The incubator system of claim 1, wherein the transparent wall is made of glass.

16. The incubator system of claim 2, wherein the transparent wall is made of glass.

17. The incubator system of claim 1, wherein the thermal flow is a circulating flow.

18. The incubator system of claim 2, wherein the thermal flow is a circulating flow.

19. The incubator system of claim 1, wherein the system further comprises a heat sink and an additional heat pump, a heat exchanger, or a Peltier element.

20. The incubator system of claim 2, wherein the system further comprises a heat sink and an additional heat pump, a heat exchanger, or a Peltier element.
